(19) United States
(12) Patent Application Publication
(10) Pub. No.: US 2017/0301168 A1
(43) Pub. Date: Oct. 19, 2017

(54) Social Network Systems and Methods for Making Informed Political Decisions

(71) Applicant: Steve Banke, Chicago, IL (US)

(72) Inventor: Steve Banke, Chicago, IL (US)

(21) Appl. No.: 15/335,683

(22) Filed: Oct. 27, 2016

Related U.S. Application Data
(60) Provisional application No. 62/258,631, filed on Nov. 23, 2015.

(51) Int. Cl. G07C 13/00; G06Q 50/00

(52) U.S. Cl. CPC G07C 13/00; G06Q 50/01; G06Q 2230/00

(57) ABSTRACT

Methods and systems for allowing users to make informed political decisions are disclosed. In one embodiment of the invention, a method of assisting users in making informed political decisions is provided. The method includes registering a user at a computer system; extracting digital information from the received registration to authenticate at least an age of the user, a geographical location of the user, a party affiliation, or a voter activity level; comparing the geographical location of the user with those of a record of elected officials in the system; allowing the users to choose channels to follow; presenting the user with unique voting opportunities based upon their choice of channels; allowing the user to vote at least once; determining the stance of at least one elected official on the at least one unique voting opportunity presented to the user; comparing the at least one stance of the elected official with the at least one vote of the user; and generating a digital scorecard detailing the findings.

### CROSS REFERENCE TO RELATED APPLICATION

This application claims the benefit of U.S. Provisional Application No. 62/258,631 filed on Nov. 23, 2015, the disclosure of which is incorporated herein by reference.

### BACKGROUND

### Field of the Invention

The present invention generally relates to web-based social network communication, and more particularly to systems and methods for assisting users in making informed political decisions and facilitating user interaction and user participation in the political process.

### Description of the Related Art

In the United States alone, there are over 500,000 elected public officials. These officials are responsible for spending a portion of each of its citizen's income and/or savings, as well as determining the rules by which their citizens learn, work, invest and live. The number of elected officials continues to rise, as elected officials continue to pass new laws and open new taxing and regulatory authorities. Local news outlets, who traditionally kept the public aware of elected officials' activities are consolidating or disappearing, while at the same time, national and global media outlets continue to become polarized and less fact based. These trends have created a situation where the average citizens' ability to understand all of the legislative and regulatory changes affecting them has become impossible. This invention provides the citizens of any elected body to easily monitor, and manage legislation passed by their elected officials, thereby giving the average citizen the ability to make informed decisions on who to vote for in each respective election.

There are survey systems that allow a content creator to ask an end user a question about a law, and to publish the results of their selections. There are news organizations, and advocacy organizations that publish information on laws that are passed by elected officials. There are government, advocacy and private organizations that publish the details of legislation and the corresponding votes cast by elected officials. There are organizations that allow end users to follow what laws are passed and how an elected official voted on that law at the federal and state level. None of these solutions connects an infinite number of advocates, representing an infinite number of voting districts, directly to an infinite number of citizens in these voting districts. None of these solutions enables a citizen to monitor all of their elected officials in all of their voting districts, in one place. None of these solutions gives a citizen reporting on how all of their elected officials are voting with or against their interests as defined on provision-by-provision basis. Furthermore, citizens may lack information such as the identity of the elected officials and the voting records of the elected officials. Citizens may lack information, for example, with respect to various pending legislative actions, elections and referenda. Other constraints on time, the ability to travel, or the ability to communicate may inhibit citizens from participating in the political process.

Accordingly, what are needed are improvements in tools and techniques to better gather and/or provide information to voters, and assisting them in being able to better make informed decisions as related to the political process, as well as be able to participate in the process and to be able interact with other users and/or potential voters.

### Statement of the Objects

These and other needs and disadvantages may be overcome by the methods and related systems disclosed herein. Additional improvements and advantages may be recognized by those of ordinary skill in the art upon study of the present disclosure.

Embodiments of the present invention address deficiencies of the art with respect to user engagement in the political process, and provide novel and non-obvious methods and systems that enable citizens to make improved informed decisions and be able to better determine which elected officials are representing their interests in government, and gives them an objective way to determine who to vote for during the elections.

An object of the invention is to enable the average citizen, and the average advocate to connect in a way that has not existed before in the history of government.

Another objective of the invention is to allow users to make informed political decisions in the voting process.

Still another objective of the invention is to provide connections between users and their legislators without space or time limitations. Which means the connections occur at the place and the time of either's choosing, making it the most convenient way for advocates to keep citizens aware of government activity.

A further objective of the invention is to make it easier for citizens to determine their views on laws that have been passed, giving citizens a clear understanding of how their elected officials are representing their interests.

A further objective of the invention is to allow users to communicate with other users of the system and become informed about the views/thoughts held by others.

Other objects and advantages of the present invention will be set forth in part in the description and in the drawings that follow and, in part, will be obvious from the description or may be learned by practice of the invention.

### SUMMARY

To achieve the foregoing objects, and in accordance with the purpose of the invention as broadly described herein, the present invention provides systems and methods for assisting users in making informed political decisions. Reference in the specification to one embodiment or an embodiment means that a particular feature, structure or characteristic described in connection with the embodiment is included in at least one embodiment of the invention. The appearance of the phrase “in one embodiment” in various places in the specification do not necessarily refer to the same embodiment.

In one embodiment of the invention, a method of assisting users in making informed political decisions is provided. The method includes registering a user at a computer system; the method includes extracting digital information from the received registration to authenticate at least an age of the user, a geographical location of the user, a party affiliation, or a voter activity level; the method includes comparing the geographical location of the user with those of a record of elected officials in the system; the method includes allowing the users to choose at least one channel to follow; the method includes presenting the user with unique voting opportunities based upon their choice of channels; the method includes allowing the user to vote at least once; the method includes determining the stance of at least one elected official on the at least one unique voting opportunity presented to the user; the method includes comparing the at least one stance of the elected official with the at least one vote of the user; and the method includes generating a digital scorecard detailing the findings.

Some embodiments include providing the user with more information about the voting opportunities before voting, other embodiments include presenting this information in the form of questions, readable text, audible sounds or web-links.

Further embodiments include allowing the user to comment on, and discuss the voting results with other system users. Still further embodiments allow the users to review their voting history by category. More embodiments allow the user to compare their voting history against their elected officials. Even further embodiments allow the system to present summaries that display voting results as related to a legislator/elected official, and/or on a system wide user basis.

Some further embodiments allow the voting opportunities and questions to be continuously populated on the user's screen.

Further embodiments allow the users to share their voting history responses via social media and e-mail messages.

Still further embodiments allow the identification of information available on elected officials who are currently in office, and to correlate each legislator to the legislation they participated in during their term. More embodiments allow the association of each provision of any law to a custom content package.

Some embodiments allow the tracking of the political and non-political careers of those who do, or have at one time, held a political office, and to associate them with the legislative votes they cast while in office.

In another embodiment a computer implemented method is disclosed. The method includes logging an administrator into the system; the method includes creating a channel with a unique set of voting opportunities or questions for a user of the system; the method includes creating content items specific to that particular channel; the method includes assigning a category to each content item; the method includes creating a people record for elected officials; and the method includes scheduling the content items to appear in a continuous ballot.

Some embodiments allow an association of the legislation with the actual votes an elected official has previously cast related to that legislation.

Further embodiments allow the content item specific to legislation to compare the official's vote to the system users' votes.

Still further embodiments allow the administrator to specify a start and stop date for each content item.

In another embodiment of the invention, a computer system for assisting a user in making informed political decisions is provided. The computerized system comprises at least one processor configured to execute software stored on a computer readable storage medium; the software being configured to cause the at least one processor to, upon execution of said software: register a user, extract digital information from the received registration to authenticate at least an age of the user, a geographical location of the user, a party affiliation, or a voter activity level, compare the geographical location of the user with those of a record of elected officials in the system, allow the users to choose channels to follow, present the user with unique voting opportunities based upon their choice of channels, allow the user to vote at least once, determine the stance of at least one elected official on the at least one unique voting opportunity presented, compare the at least one stance of the elected official with the at least one vote of the user; and generate a digital scorecard detailing the findings.

The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

The present invention will now be described with reference to the following drawings, in which like reference numbers denote the same element throughout.

### BRIEF DESCRIPTION OF THE DRAWINGS

FIG. 1 illustrates by process flow chart an exemplary implementation of the overall system.

FIG. 2 is an exemplary screen shot of a portion of the user's interface as relating to the ballot screen.

FIG. 3 is an exemplary screen shot of a portion of the user's interface as relating to the learn more screen.

FIG. 4 is an exemplary screen shot of a portion of the user's interface as relating to the results screen.

FIG. 5 is an exemplary screen shot of a portion of the user's interface as relating to the comments screen.

FIG. 6 is an exemplary screen shot of a portion of the user's interface as relating to the score-card screen.

FIG. 7 is an exemplary screen shot of a portion of the user's interface as relating to the votes screen.

FIG. 8 provides a flowchart illustrating logic that may be used when implementing preferred embodiments of the current invention.

### DETAILED DESCRIPTION

Embodiments of the present invention are described more fully below with reference to the accompanying drawings, which form a part hereof, and which show exemplary embodiments for practicing the invention. However, embodiments may be implemented in many different forms and should not be construed as limited to the embodiments set forth herein; rather these embodiments are provided so that this disclosure will be thorough and complete, and will fully convey the scope of the invention to those skilled in the art. The following detailed description is, therefore, not to be taken in the limiting sense.

As will be appreciated by one skilled in the art, aspects of the present invention may be embodied as a system or a method. Accordingly, aspects of the present invention may take the form of an entirely hardware embodiment, an entirely software embodiment (including firmware, resident software, micro-code, etc.) or an embodiment combining software and hardware aspects that may all generally be referred herein to as a “system.” Further definitions of terms used within the application are as follows:
a. Content—editor and user generated information stored in items;
b. Did you know—content in an item that is displayed to inform the user;
c. Editor—system administrator who creates content;
d. Item—a data container that holds editor and user generated content;
e. Legislation—actual bills and laws that are processed by legislators;
f. Page—describes the name of a screen of data;
g. Question—content that is displayed for the user to vote on;
h. User—the person who receives and interacts with items; and
i. Vote—a function that enables a user to indicate their selection for a question.

The present invention is described below with reference to flowchart illustrations and/or block diagrams of methods and systems according to embodiments of the invention. It will be understood that each block of the flowchart illustrations and/or block diagrams, and combinations of blocks in the flowchart illustrations and/or block diagrams, can be implemented by computer program instructions, these computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow chart and/or block diagram.

Although the disclosure herein refers to certain embodiments, it is to be understood that these embodiments are presented by way of example and not by way of limitation. The intent of this disclosure, while discussing exemplary embodiments, is that the following detailed description be construed to cover all modifications, alternatives, and equivalents of the embodiments as may fall within the spirit and scope of the invention as defined by the appended claims. It is to be understood and appreciated that the process steps and structures described herein do not cover a complete process flows. The present invention may be practiced in conjunction with various techniques that are conventionally used in the art, and only so much of the commonly practiced process steps are included herein as are necessary to provide an understanding of the present invention.

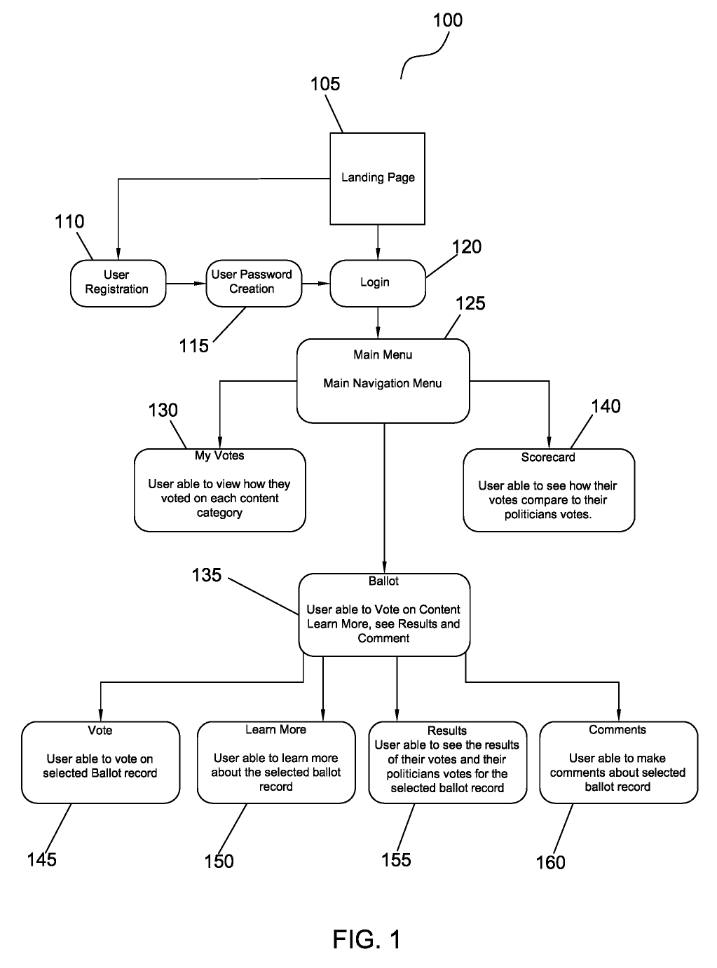

Referring now to the figures, FIG. 1 illustrates by process flow chart an exemplary implementation of the overall system.

In one embodiment of the invention, a user can access the system 100, via the landing page 105, wherein the landing page 105 is accessed by typing in the associated website in an internet browser. Once on the landing page 105 the user has to create a user registration 110 as well as a password 115, which will then allow the user to be able to login 120 to the website. For the user registration 110, relevant information required from the user may be, but not limited to, the name, email address, postal address, zip code, party affiliation, voter registration, geographical location, etc. A user login 120 allows the user to be associated with unique voting opportunities based upon their preferences that the system 100 gauges. The system determines these user preferences, based upon the channels a user chooses to follow. A user can elect to follow one or multiple channels upon logging into 120 the system 100. Furthermore, each channel contains a unique set of questions or voting opportunities, which are continuously populated into the user's feed upon him logging in 120.

Furthermore, once a user logs in 120 he is taken to the main menu 125 wherein the user is provided with some navigation options. From the main menu 125 the user can choose to click on the ‘my votes’ screen 130, wherein the user is able to view how he/she voted in each category. Another tab the user can click upon is the scorecard tab 140 wherein the system 100 is prompted to display how the user's votes compared in relation to his/her elected official. The user can also click on the ballot tab 135. The ballot tab 135 provides the user with further options to choose from, namely, vote on content 145, learn more 150, see results, 155 and comment on, 160. Vote on content 145 option allows the user to vote on a selected content type. The ballot screen continuously populates content items or questions, and the system 100 allows each user to vote upon them, in the form of likes (thumbs up) or dislikes (thumbs down).

Each content package is called a ‘DeepVote’. Each DeepVote enables a user to learn about, and vote upon, a provision from any piece of legislation. Each DeepVote is organized into channels, and the user can select what DeepVote packages they wish to see in their continuous ballot 135 by selecting the channels they wish to follow. Each DeepVote package contains one, or a series of custom developed value-based questions. Furthermore, Legislative DeepVote packages are special in that they are also associated to a provision of an actual piece of legislation, and the votes cast by elected officials for that piece of legislation. Based on the channels selected by the user, uniquely filtered DeepVote opportunities are queued up for them in their ballot 135 and the user can review, and vote upon them, at the time and place of their choosing.

The learn more tab 150 includes unique content generated by the system 100, with references to corresponding publications, studies and other related information that the user can read, listen to, or watch via web-links. The unique content, and references, enable the end user to learn about the background of each question before deciding if they agree or disagree with the law's provision.

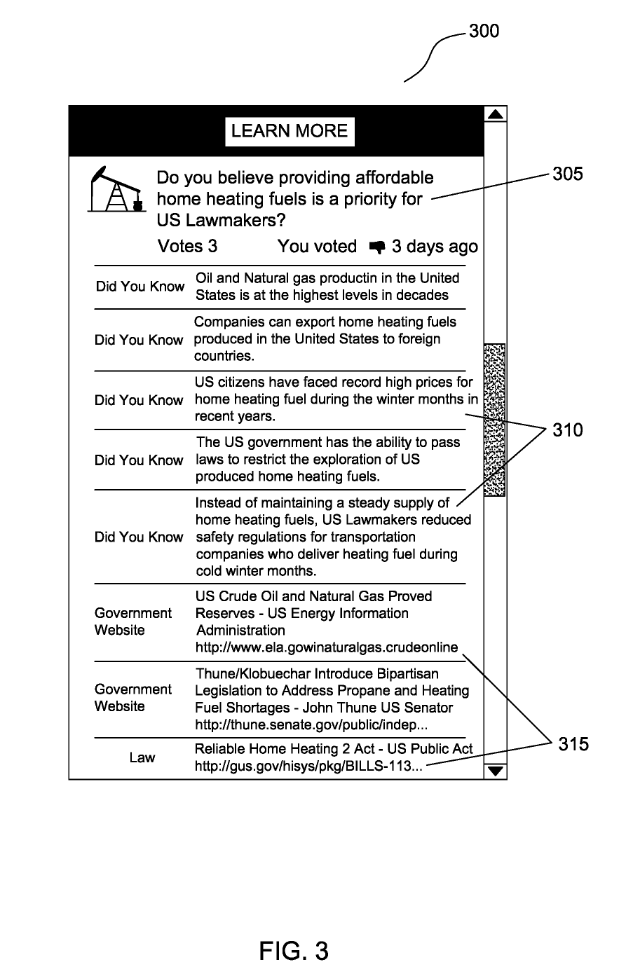

The see results tab 155, allows a user to see the results of their vote (agree or disagree) and their politician's vote (yes or no) for the selected ballot. The results tab 155, generates various reports, as seen more in detail in FIG. 3. The first report shows how the community in general is voting for or against the law. The second report shows the user how he voted on that particular law/question. The third report shows the user how various elected official, representing the user, have voted upon that particular law.

Moving along, the comments tab 160 allows a user to comment on and discuss the voting results from the results tab 155 with other system users.

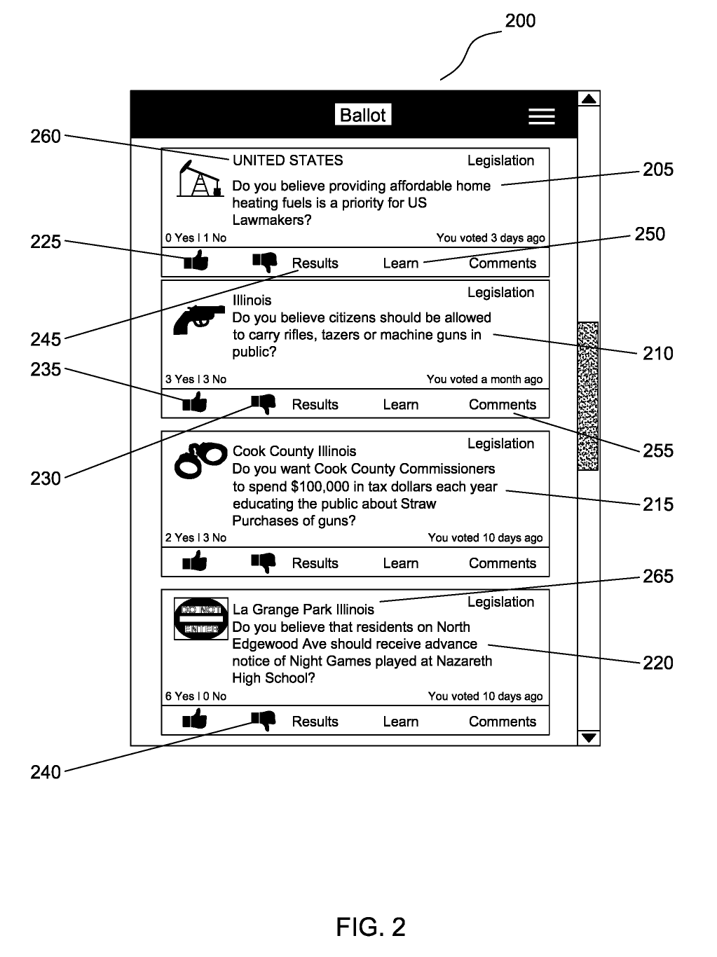

FIG. 2 depicts an exemplary screen shot of a portion of the user's interface as it relates to the ballot screen 200. Once a user logs into the system 100, he/she is given the option to be redirected to the continuous ballot screen 200. Based on the channel selected by the user, uniquely filtered questions are queued up for the user in the ballot screen 200 and the user can review and vote for them at the time and place of his/her choosing. On this screen the user is presented with a number of questions, for example, 205, 210, 215 and 220. As an example, question 205 may ask the user do you believe providing affordable home heating fuels is a priority of United States lawmakers? The user has the option to either agree, 225, 235, (thumbs up) with the specific questions asked 205, 210, 215, 220, or disagree 230, 240, (thumbs down). The user responses are then recorded by the system 100. The user can also opt to check out the results 245 to see how other users, or the lawmakers voted. Or before voting, the user can opt to learn more about the content 250, and/or also comment on, and discuss the voting results 255. Also at the top of each question, 205, 210, 215 and 220, is indicated what geographical location (county, city state or country) 260, 265, the particular inquiry relates to. The invention allows DeepVotes to be presented in many formats on the ballot screen 200 including, but not limited to, legislative review, opinion polls, training modules, donation requests and advertising requests. Specifically, for legislative content, the DeepVote package is also compared to the elected officials actual vote on the law.

FIG. 3 depicts an exemplary screen shot of a portion of the user's interface as it relates to the ‘learn more’ screen 300. At the top of the screen is displayed a custom developed value-based question 305 the user can learn more about. Underneath are displayed a series of factual information 310 about the question 305. There are also provided web-links 315 to information sources related to the question 305. This screen enables people with little or no knowledge of the topic to learn more about, and then subsequently vote upon the question being presented.

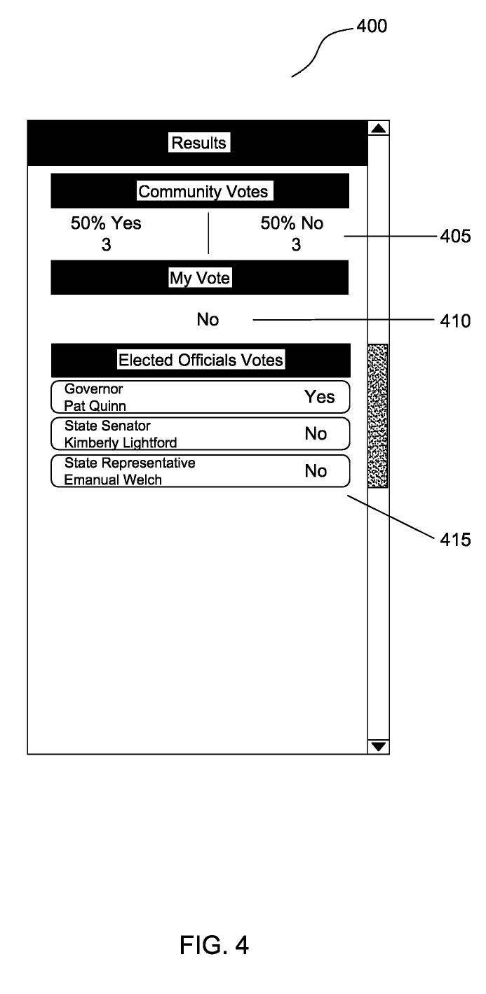

FIG. 4 depicts an exemplary screen shot of a portion of the user's interface as it relates to the results screen 400. As shown in 405 the results are tabulated as against other users of the system 100. As displayed in 405 this shows how many other users voted with or against a user on a particular question/issue. Further down at 410 the system 100 tabulates how the user himself voted. And lastly the system displays at 415 how various elected officials voted upon that particular law 410.

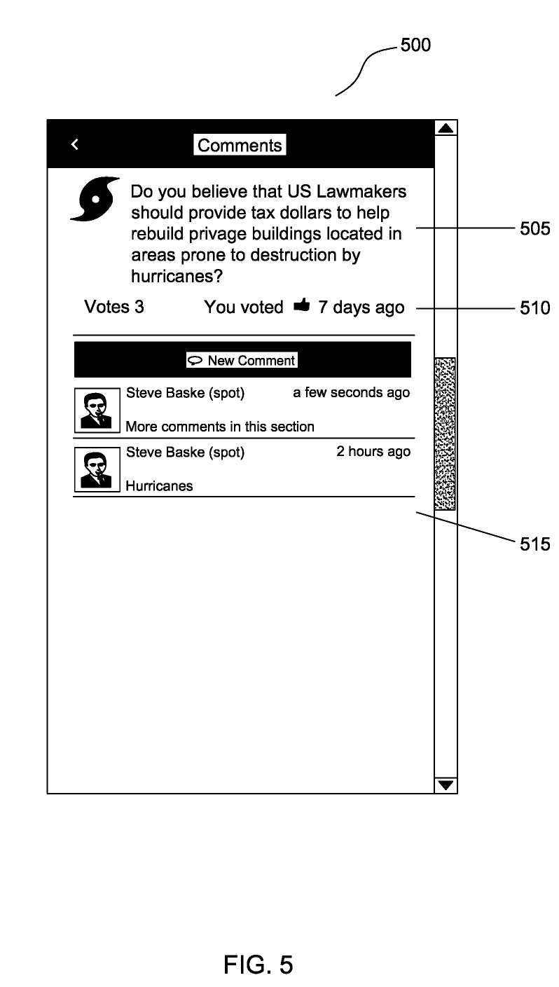

FIG. 5 is an exemplary screen shot of a portion of the user's interface as it relates to the comments screen 500. At the top of the screen 500 is displayed the particular question 505 the user voted on. Below it is displayed how the user voted 510. The user can then choose to comment upon, or view other system users' comments 515, thus making it an interactive process.

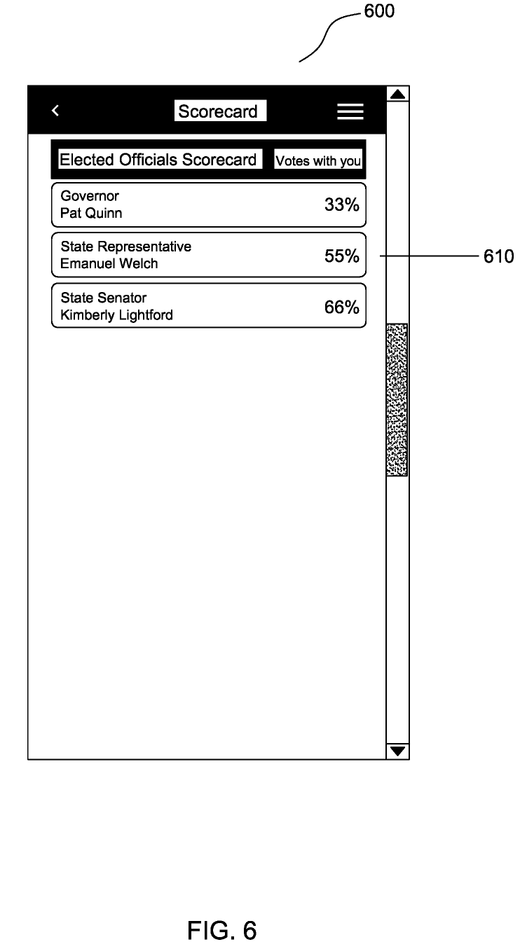

FIG. 6 depicts an exemplary screen shot of a portion of the user's interface as it relates to the score-card screen 600. Once a user completes a number of legislative DeepVote packages, the user is able to see the trends of on their score card screen 600, which indicates if their elected officials are voting with or against them, and the percentage of times that a particular elected official is voting with a certain user, as displayed in 610. The score-card is unique for each individual user, the user's vote is compared to their legislator, and shows a comparison for the user's votes and the elected official's vote for each channels that the user is following and voting on.

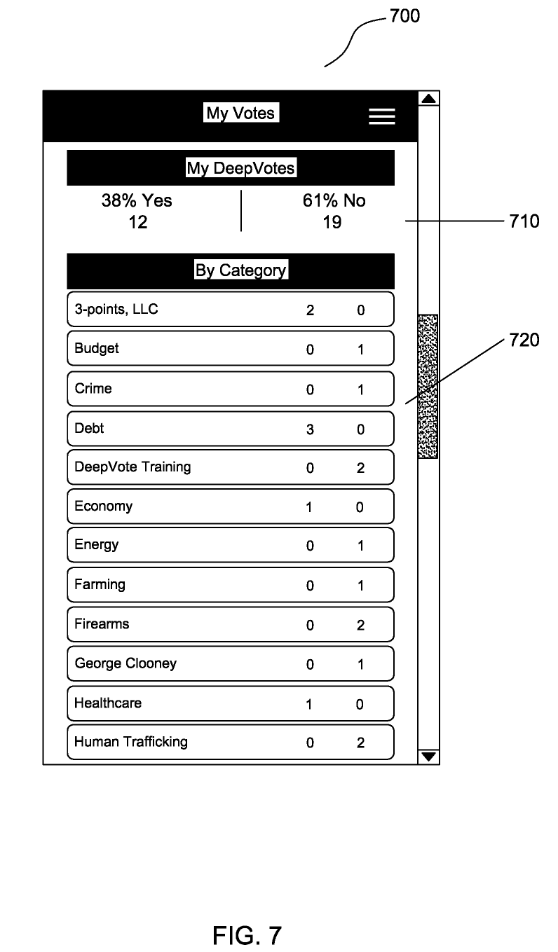

FIG. 7 depicts an exemplary screen shot of a portion of the user's interface as it relates to the ‘my vote’ screen 700. The screen breaks down the votes by a yes or no 710 tabulating how often the user agreed or disagreed with a particular question. The screen further tabulates by category 720 how the user voted yes or no to a particular category of questions, wherein each category is a reference to a particular channel the user has chosen to follow.

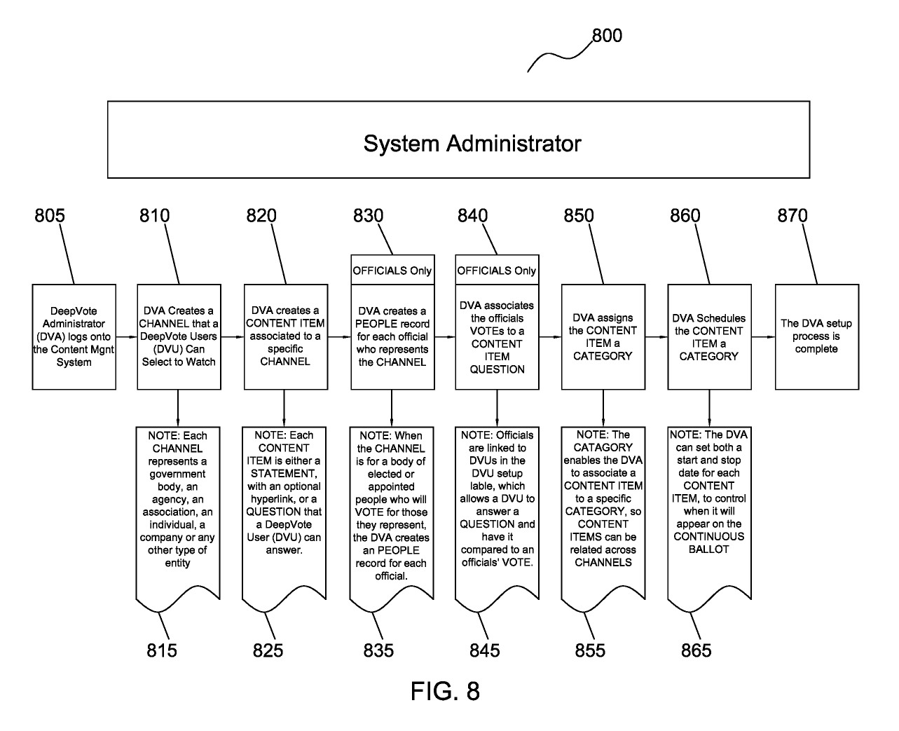

FIG. 8 depicts an overview process flow of how the backend of the system or the system administration 800 works. To initiate, an administrator 805 logs into the system 100. The administrator 805 then creates a channel 810 that the user of the system 100 can choose to click on. As stated in box 815, this channel 810 can be a government body, an agency, an association, an individual, a company or any other type of entity. Furthermore, the channel 810 allows an administrator 805 to identify a specific type of DeepVote and allow the user to receive that specific type of DeepVote in their continuous ballot screen.

Once the channel 810 is created, then the administrator 805 creates the content item 820 associated with that particular channel 810. As stated in box 815 each content item 820 is either a statement regarding the content item 820 with a web-based hyperlink, or a question that the user can answer. For example, for legislative content, each content item 820 is associated to a provision of an actual piece of legislation, and the actual votes that elected officials cast for that piece of legislation. Furthermore, for legislative content the DeepVote package is also compared to the elected officials' actual vote of the respective law. The results of these votes are then compared, and tabulated, using an algorithm. The invention reports the users results against all system users. The creates a unique “legislator-scorecard” for each individual user, which allows the comparison for the user's votes, and the elected officials' votes, for those channels the end user is following and voting on. Moreover, while creating the content item 820 the administrator can also determine what type of behavior a DeepVote package will exhibit, and whether or not it will compare the results with elected officials.

Moving along, the system 100 will also allow the administrator 805 to create a people record 830 for each official that represents the channel 810. As clarified by box 835 when the channel 810 is for a body of elected or appointed people who will vote for, or those they represent, the administrator creates a people record 830 for each official. In other words, the people record 830 is a data base of elected officials that is correlated to the users' voting districts and specific votes cast by each official during the time they held office, wherein each user's voting district is determined by using geographical location, in particular by their zip code entered at the time of registration. Furthermore, at this stage the system 100 allows the administrator 805 to make further additions to the people record 830. For example, the administrator 805 may define any branch of government or other non-government organization that a user could vote on; the administrator 805 may define each district within a branch; the administrator 805 may insert the political affiliation of a legislator; the administrator 805 may further associate the branches of an organization, and legislation, to a specific session in which the votes occurred; the administrator 805 may also log the political group affiliation of an elected official; the administrator 805 may identify the career positions of the elected official as either public or private; the administrator 805 may associate an elected official's title with a branch of an organization; the administrator 805 may log the vote of the elected official tracked in the system 100 based upon the specific voting options they have within their branch of their organization etc.

Furthermore, the system 100 allows the administrator 805 to associate the elected officials votes to a content item question 840. As stated in 845, what this means is that elected officials are so linked to a user that when a user answers a question 840, then that response is compared to the vote of an elected official.

Moreover, the system 100 further allows the administrator 805 to assign the content item a category 850. As stated in 855 the category 850 enables the administrator 805 to associate a content item to a specific category 850 so that the similar content items can be related across channels 810. Some examples of categories could be crime, affirmative action, budget, college etc., as displayed in the categories section in FIG. 7 720. Note that these are just a few of the many examples of categories that could be utilized.

The system 100 further allows the administrator 805 to schedule the content item to appear in the continuous ballot 860. As stated in 865 the administrator 805 can set up both a start and stop date for each content item, to control when it will appear on the ballot screen for a user of the system 100. The administrator can set the status of a content item as active, pending or retired, thereby determining whether these are visible to the end user. This ensures that the questions posed to the users are accurate and up to date. This finishes the system administration setup 870.

Thus, the embodiments disclosed herein can aid voters in determining whether they are properly being represented by their elected candidates, as well as which candidate would best represent their views. The embodiments disclosed herein can also allow a user to share their voting behaviors, results and thoughts with others via the use of email and other social media, integrated within the system.

Although the above operational flow is described in a sequential manner, in other embodiments some operations may be performed in different orders or concurrently. Also, although the invention has been described in language specific to structural features and/or methodological steps, it is to be understood that the invention defined in the appended claims is not necessarily limited to the specific features or steps described. Rather, the specific features and steps are disclosed as forms of implementing the claimed invention. Since many embodiments of the invention can be made without departing from the spirit and scope of the invention, the invention resides in the claims hereinafter appended.

What is claimed is:

1. A computer implemented method of assisting users in making informed political decisions, comprising:
a. Registering a user at a computer system;
b. Extracting digital information from the received registration to authenticate at least an age of the user, a geographical location of the user, a party affiliation, or a voter activity level;
c. Comparing the geographical location of the user with those of a record of elected officials in the system, wherein such a comparison allows the user to be positively correlated with his/her respective elected officials;
d. Allowing the user to choose at least one channel to follow;
e. Presenting the user with unique voting opportunities based upon the at least one channel the user has chosen to follow;
f. Allowing the user to vote at least once;
g. Determining a stance of the at least one elected official on the at least one unique voting opportunity presented to the user;
h. Comparing the stance of the at least one elected official with the at least one vote of the user; and
i. Generating a digital scorecard.

2. The computer implemented method of claim 1, wherein the voting opportunities are continuously populated on the user's screen.

3. The computer implemented method of claim 1, wherein the voting opportunities may be presented in the form of questions.

4. The computer implemented method of claim 1, wherein the user is provided with further learning opportunities before choosing to vote.

5. The computer implemented method of claim 1, wherein determining the stance of the at least one political figure comprises receiving input regarding at least one actual vote the political figure casted for that particular stance during the official's time in office.

6. The computer implemented method of claim 1, further comprising displaying a comparison of the user's voting history to the stance of his/her elected official in that particular category.

7. The computer implemented method of claim 1, further comprising allowing the user to review his/her voting history by each category of channels the user has chosen to follow.

8. The computer implemented method of claim 1, further comprising displaying a comparison of the user's voting history to the voting history of system wide users.

9. The computer implemented method of claim 1, further comprising allowing the user to view and comment upon the voting results from a particular category.

10. A computer implemented method, comprising:
a. Logging an administrator into the system;
b. Creating a channel with a unique set of voting opportunities or questions for a user of the system;
c. Creating content items specific to that particular channel;
d. Assigning a category to each content item;
e. Creating a people record for elected officials; and
f. Scheduling the content items to appear in a continuous ballot.

11. The computer implemented method of claim 10, wherein the content item specific to legislation further comprises an association of the legislation with the actual votes an elected official has previously cast related to that legislation.

12. The computer implemented method of claim 11, wherein the content item specific to legislation further comprises a comparison of the official's vote to the system users' votes.

13. The computer implemented method of claim 10, wherein the people record is a database of elected officials who are correlated to the users' voting districts.

14. The computer implemented method of claim 13, wherein the people record further comprises the specific votes cast by each official during the time they held office.

15. The computer implemented method of claim 13, wherein the user's voting district is determined by the zip code entered at the time of user registration.

16. The computer implemented method of claim 10, wherein the administrator can specify a start and stop date for each content item.

17. A system for assisting a user in making informed political decisions, comprising:
a. at least one processor configured to execute software stored on a computer readable storage medium, the software being configured to cause the at least one processor to, upon execution of said software:
b. Register a user at a computer system;
c. Extract digital information from the received registration to authenticate at least an age of the user, a geographical location of the user, a party affiliation, or a voter activity level;
d. Compare the geographical location of the user with those of a record of elected officials in the system, wherein such a comparison allows the user to be positively correlated with his/her respective elected officials;
e. Allow the user to choose at least one channel to follow;
f. Present the user with unique voting opportunities based upon the at least one channel the user has chosen to follow;
g. Allow the user to vote at least once;
h. Determine the stance of the at least one elected official on the at least one unique voting opportunity presented to the user;
i. Compare the at least one stance of the elected official with the at least one vote of the user; and
j. Generate a digital scorecard.

18. The computer system of claim 17, wherein the voting opportunities are continuously populated on the user's screen.

19. The computer system of claim 17, wherein the voting opportunities may be presented in the form of questions.

20. The computer system of claim 17, wherein the user is provided with further learning opportunities before choosing to vote.

21. The computer system of claim 17, wherein determining the stance of the at least one political figure comprises receiving input regarding at least one actual vote the political figure casted for that particular stance during the official's time in office.

22. The computer system of claim 17, further comprising displaying a comparison of the user's voting history to the stance of his/her elected official in that particular category.

23. The computer system of claim 17, further comprising allowing the user to review his/her voting history by each category of channels the user has chosen to follow.

24. The computer system of claim 17, further comprising displaying a comparison of the user's voting history to the voting history of system wide users.

25. The computer system of claim 17, further comprising allowing the user to view and comment upon the voting results from a particular category.
